(19) United States
(12) Patent Application Publication
(10) Pub. No.: US 2019/0024885 A1
(43) Pub. Date: Jan. 24, 2019

(54) FLOATING WICK

(71) Applicants: ELIAS OR HAIM, PETACH TIKVA (IL); BRACHA YASSI, PETACH TIKVA (IL); DAVID YASSI, PETACH TIKVA (IL)

(72) Inventors: ELIAS OR HAIM, PETACH TIKVA (IL); BRACHA YASSI, PETACH TIKVA (IL); DAVID YASSI, PETACH TIKVA (IL)

(21) Appl. No.: 15/815,996

(22) Filed: Nov. 17, 2017

(30) Foreign Application Priority Data
Jul. 24, 2017 (IL) 253643

(51) Int. Cl. F23D 3/24; F21V 37/00

(52) U.S. Cl. CPC F23D 3/24; F21V 37/002

(57) ABSTRACT

A floating wick that can be used like a candle. The floating wick includes a cup-shaped floating element with a bottom oil-interfacing portion having a through-hole with a capillary tube extending upward from the through-hole. The floating wick can be placed on a pool of flammable oil and the upper end of the capillary tube can be lit like a candle wick.

### CROSS REFERENCE TO RELATED APPLICATIONS

The present patent application claims priority from Israel patent application IL 253643 entitled “Floating wick”, filed on 24 Jul. 2017, the complete disclosures of each of which are hereby incorporated by reference.

### FIELD OF THE INVENTION

The present invention relates to lighting, more specifically to a device to provide oil-candle light.

### BACKGROUND OF THE INVENTION

Oil candles in various configurations are an alternative to electric lighting, are simple to make or inexpensive to purchase, and can add ambiance to a room. Such oil candles can be as simple as a “do-it-yourself” oil candle produced by placing a wick in a jar of oil with one end of the wick supported above the surface of the oil.

Examples of more sophisticated oil candles are disclosed in U.S. Pat. No. 6,159,002 (LeJeune, 2000 Dec. 12); U.S. Pat. No. 6,991,453 (Decker et al., 2006 Jan. 31); and WO 2002/1010643 (Tan, 2002 Feb. 7).

### SUMMARY OF THE INVENTION

The present invention relates to a floating wick for use as a candle or heating. The floating wick is configured to float on a pool of oil and cause the oil to rise in a capillary tube of the floating wick, as a result of which the oil can be lit at the top of the capillary tube.

It should be understood that the floating wick can be manufactured as a one-piece device, for example as a thin-walled metallic body or of glass or the like. Alternatively, the floating wick can be manufactured with separate components.

According to embodiments of the present invention there is provided a floating wick including a cup-shaped floating element with a bottom oil-interfacing portion having a through-hole with a capillary tube extending upward from said through-hole.

In some embodiments, the cup-shaped portion and the capillary tube are separate components and the capillary tube is sealing fitted in the through-hole of said bottom oil-interfacing portion.

In some embodiments, the floating further includes a floatation member attached to the underside of the bottom oil-interfacing portion or to the lower end of the capillary tube.

In some embodiments, the underside of the bottom oil-interfacing portion includes a recess that is configured to receive the floatation member.

In some embodiments, the floatation member is configured to fix and seal the capillary tube to the bottom oil-interfacing portion.

### BRIEF DESCRIPTION OF THE DRAWINGS

The invention may be more clearly understood upon reading of the following detailed description of non-limiting exemplary embodiments thereof, with reference to the following drawings, in which:

FIG. 1 is side-sectional view of a floating wick in accordance with embodiments of the present invention;

FIG. 2 is side-sectional view of in accordance with another embodiment of the present invention; and

FIG. 3 is an exploded perspective view of FIG. 2.

The following detailed description of embodiments of the invention refers to the accompanying drawings referred to above. Dimensions of components and features shown in the figures are chosen for convenience or clarity of presentation and are not necessarily shown to scale. Wherever possible, the same reference numbers will be used throughout the drawings and the following description to refer to the same and like parts.

### DETAILED DESCRIPTION OF THE INVENTION

Illustrative embodiments of the invention are described below. In the interest of clarity, not all features/components of an actual implementation are necessarily described.

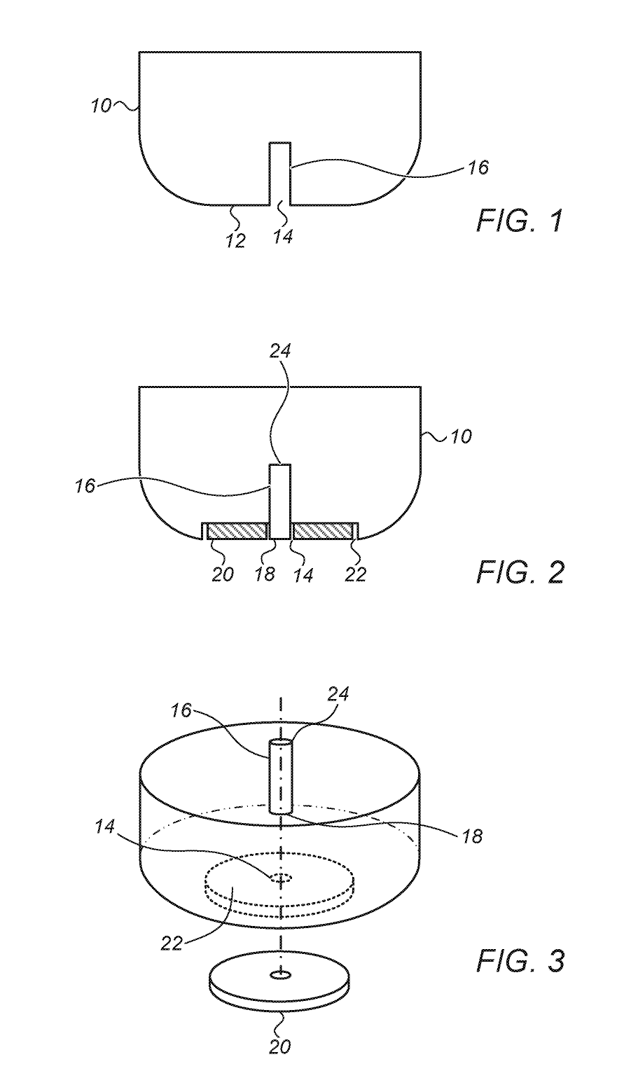

FIG. 1 shows a floating wick in accordance with embodiments of the present invention. The floating wick includes a cup-shaped floating element 10 with a bottom oil-interfacing portion 12 having a through-hole 14 with a capillary tube 16 extending upward from the through-hole.

The floating wick can be manufactured as a one-piece device, for example as a thin-walled metallic body or of glass or the like. Alternatively, in some embodiments, the floating wick can be manufactured using separate components (FIGS. 2 and 3), for example, wherein capillary tube 16 is made of glass and cup-shaped floating element 10 with its bottom oil-interfacing portion 12 are metallic —without limitation to materials.

In such embodiments, cup-shaped floating element 10 and capillary tube 16 are configured to seal fit together, i.e. a lower end 18 of the capillary tube is sealingly attached (e.g. by a welding or stamping process) or adhered to (e.g. by a suitable adhesive) through-hole 14 of bottom oil-interfacing portion 12.

In some embodiments, the floating wick includes a floatation member 20 attached to the underside of bottom oil-interfacing portion 12; or to lower end 18 of capillary tube 16 (FIGS. 2 and 3).

In some embodiments, the underside of bottom oil-interfacing portion 12 includes a recess 22 configured to receive floatation member 20 (FIGS. 2 and 3).

In some embodiments, floatation member 20 is configured to fix and seal capillary tube 16 to bottom oil-interfacing portion 12 (best seen in FIG. 2).

To operate the floating wick, the wick is placed on a pool of flammable oil, such as vegetable oil, and after a short wait for the oil to rise in capillary tube 16, the free (upper) end 24 of the capillary tube is lit I.e. the oil/oil vapor is lit. Capillary tube 16 is dimensioned whereby the flammable oil rises upward in the tube when the floating wick is placed on the flammable oil.

It should be understood that the above description is merely exemplary and that there are various embodiments of the present invention that may be devised, mutatis mutandis, and that the features described in the above-described embodiments, and those not described herein, may be used separately or in any suitable combination; and the invention can be devised in accordance with embodiments not necessarily described above.

What is claimed is:

1. A floating wick comprising a cup-shaped floating element with a bottom oil-interfacing portion having a through-hole with a capillary tube extending upward from said through-hole.

2. The floating wick of claim 1, wherein the cup-shaped portion and the capillary tube are separate components and the capillary tube is sealing fitted in the through-hole of said bottom oil-interfacing portion.

3. The floating wick of claim 1, further comprising a floatation member attached to the underside of the bottom oil-interfacing portion or to the lower end of the capillary tube.

4. The floating wick of claim 3, wherein said underside of the bottom oil-interfacing portion includes a recess that is configured to receive the floatation member.

5. The floating wick of claim 3, wherein said floatation member is configured to fix and seal the capillary tube to the bottom oil-interfacing portion.
